(19) United States
(12) Patent Application Publication
(10) Pub. No.: US 2026/0049375 A1
(43) Pub. Date: Feb. 19, 2026

(54) METHOD FOR RECOVERING METALS

(71) Applicant: JX METALS CIRCULAR SOLUTIONS CO., LTD., Tokyo (JP)

(72) Inventors: Atsushi FUJIMOTO, Hitachi-shi (JP); Hidemasa KAWAI, Hitachi-shi (JP); Hirotaka ARIYOSHI, Hitachi-shi (JP)

(73) Assignee: JX METALS CIRCULAR SOLUTIONS CO., LTD., Tokyo (JP)

(21) Appl. No.: 19/103,668

(22) PCT Filed: Nov. 9, 2023
(86) PCT No.: PCT/JP2023/040447

§ 371 Date: Feb. 13, 2025

(30) Foreign Application Priority Data
Nov. 14, 2022 (JP) 2022-182018

(51) Int. Cl. C22B 3/00; C01D 15/02; C22B 3/32; C22B 3/44; C22B 26/12; H01M 10/54

(52) U.S. Cl. CPC C22B 23/0453; C01D 15/02; C22B 3/32; C22B 3/44; C22B 26/12; H01M 10/54

(57) ABSTRACT

A method for recovering metals from a metal-containing solution containing nickel ions, lithium ions, and anions of an inorganic acid, the method including: a nickel extraction step including extraction that mixes the metal-containing solution with a solvent while adjusting an equilibrium pH using a pH adjusting agent containing lithium ions, transfers the nickel ions in the metal-containing solution to the solvent, and separates the solvent containing the nickel ions from an extracted solution, wherein in the nickel extraction step, the extraction is carried out under conditions where the total of a lithium ion concentration of the metal-containing solution and a lithium ion concentration of the pH adjusting agent is less than or equal to a lithium ion concentration of a saturated solution of a lithium salt made of the anions of the inorganic acid and the lithium ions contained in the metal-containing solution.

### TECHNICAL FIELD

This specification describes a method for recovering metals from a metal-containing solution.

### BACKGROUND ART

When recovering metals from ores or wastes such as electrical/electronic devices or lithium ion batteries, solvent extraction can be used for a metal-containing solution obtained by leaching metals in the ores or wastes into an acidic leaching solution or the like (see, for example, Patent Literatures 1 and 2).

In the above solvent extraction method, the metal-containing solution is brought into contact with a solvent, and a predetermined metal ion among multiple types of metal ions in the metal-containing solution is extracted from the metal-containing solution into the solvent. This can lead to separation of predetermined metal ions from other metal ions in the metal-containing solution. In addition, the solvent may be then brought into contact with a stripping solution, so that metal ions in the solvent may be stripped into the stripping solution.

### CITATION LIST

### Patent Literature

PTL 1: WO 2018/181816 A1
PTL 2: U.S. Patent Application Publication No. 2020/0044295 A1

### SUMMARY OF INVENTION

### Technical Problem

By the way, when nickel ions are extracted into the solvent from the metal-containing solution containing nickel ions and lithium ions using the solvent extraction method, precipitates may be generated. In this case, the precipitates inhibit the smooth progress of the nickel ion extraction operation, and in some cases, the operation will have to be interrupted.

This specification provides a method for recovering metals, which can effectively suppress the generation of precipitates during extraction of nickel ions.

### Solution to Problem

The method for recovering metals disclosed in this specification is a method for recovering metals from a metal-containing solution containing nickel ions, lithium ions, and anions of an inorganic acid, the method comprising: a nickel extraction step including extraction that mixes the metal-containing solution with a solvent while adjusting an equilibrium pH using a pH adjusting agent containing lithium ions, transfers the nickel ions in the metal-containing solution to the solvent, and separates the solvent containing the nickel ions from an extracted solution, wherein, in the nickel extraction step, the extraction is carried out under conditions where the total of a lithium ion concentration of the metal-containing solution and a lithium ion concentration of the pH adjusting agent is less than or equal to a lithium ion concentration of a saturated solution of a lithium salt made of the anions of the inorganic acid and the lithium ions contained in the metal-containing solution.

### Advantageous Effects of Invention

According to the above method for recovering metals, the generation of precipitates during extraction of nickel ions can be effectively suppressed.

### BRIEF DESCRIPTION OF DRAWINGS

FIG. 1 is a flowchart illustrating an example of a process including a method for recovering metals according to an embodiment.

FIG. 2 is a flowchart illustrating an example of each process for obtaining battery powder from lithium ion battery waste.

FIG. 3 is a graph showing a change of a lithium ion concentration in each solution over time during nickel ion extraction in Test Example 1 of Examples.

FIG. 4 is a graph showing changes of a lithium ion concentration and a sodium ion concentration in a metal-containing solution over time in Test Example 2 of Examples.

### DESCRIPTION OF EMBODIMENTS

Hereinafter, embodiments of the above method for recovering metals will be described in detail.

The method for recovering metals according to an embodiment is a method for recovering metals from a metal-containing solution containing nickel ions, lithium ions, and anions of an inorganic acid, and includes a nickel extraction step using a solvent extraction method.

The nickel extraction step includes extraction that transfers the nickel ions from the metal-containing solution to a solvent. More particularly, in the extraction of the nickel extraction step, for example, a mixer-settler or the like may be used, and the nickel ions in the metal-containing solution may be transferred to the solvent in the mixer, and the solvent containing the nickel ions and an extracted solution may be then separated by specific gravity separation in the settler.

It has been newly found that in such extraction, lithium-containing precipitates are generated in the mixer-settler if the lithium ion concentration of the metal-containing solution is high to a certain extent. If the precipitates are generated, the extraction operation cannot be smoothly carried out and may have to be interrupted in order to remove the precipitates. However, as a result of intensive studies, the present inventors have found that when a pH adjusting agent containing lithium ions and the metal-containing solution are brought into contact with each other, there is local and significant increase in a lithium ion concentration, which will lead to the generation of the precipitates. At such a relatively small contact point, when the total of the lithium ion concentration of the pH adjusting agent and the lithium ion concentration of the metal-containing solution exceeds a lithium ion concentration of a saturated solution of lithium salts made of the anions of the inorganic acid and the lithium ions in the metal-containing solution (hereinafter also referred to as a “lithium ion concentration of a saturated lithium salt solution”), the lithium salts are precipitated, and as the metal-containing solution and the solvent are under conditions of being mixed and stirred, the surface is covered with the solvent immediately after precipitation and cannot be redissolved, which is presumed to become the precipitates. Based on this finding, in this embodiment, the lithium ion concentration of each solution is adjusted so that the total of the lithium ion concentration of the metal-containing solution and the lithium ion concentration of the pH adjusting agent is equal to or less than the lithium ion concentration of the saturated lithium salt solution, and the extraction is then carried out. This prevents the lithium ion concentration from locally exceeding the solubility during contact between the pH adjusting agent and the metal-containing solution, thereby effectively suppressing the generation of precipitates during the extraction of the nickel ions. Preferably, although it depends on the lithium ion concentration of the pH adjusting agent and the like, the lithium ion concentration of the metal-containing solution is previously controlled to a lower level in the settler so that the lithium ion concentration of the extracted solution separated from the solvent is less than 15 g/L, whereby the generation of precipitates can be more effectively suppressed. In this embodiment, it is preferable to adjust the lithium ion concentration of the metal-containing solution so that the lithium ion concentration of the extracted solution separated from the solvent in the extraction of the nickel extraction step are less than 15 g/L. This allows the generation of precipitates to be further suppressed. As a result, a stable operation of the method for recovering metals becomes possible.

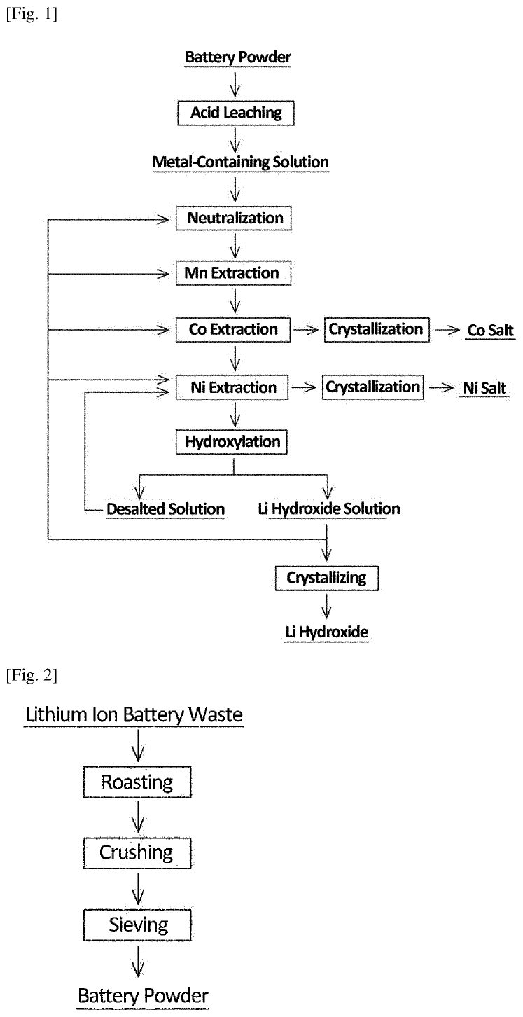

The method for recovering metals according to the above embodiment can be used, for example, in a wet treatment process for recovering metals from battery powder of lithium ion battery waste as shown in FIG. 1. This process includes: an acid leaching step of leaching the metals in the battery powder to obtain the metal-containing solution; a neutralization step, a manganese extraction step, a cobalt extraction step, a nickel extraction step and a nickel extraction step, which are performed for the metal-containing solution; a hydroxylation step of preparing a lithium hydroxide solution from an extracted solution in the nickel extraction step; and a crystallization step of obtaining lithium hydroxide from a lithium hydroxide solution obtained in the hydroxylation step. The battery powder may be obtained by subjecting lithium ion battery waste to preprocessing steps such as roasting, crushing, and sieving, as illustrated in FIG. 2. Although the descriptions will be given herein according to FIGS. 1 and 2, FIGS. 1 and 2 are merely illustrative, and are not limited to such specific flows.

### (Lithium Ion Battery Waste)

The lithium ion battery waste of interest is lithium ion batteries which can be used in various electronic devices such as mobile phones and which have been discarded due to the expired life of the product, manufacturing defects or other reasons. The recovery of valuable metals from such lithium ion battery waste is preferred in terms of effective utilization of resources. The lithium ion battery waste refers to lithium ion batteries to be recycled, regardless of whether the lithium ion batteries are traded for a fee, at no charge, or as industrial waste.

The lithium ion battery waste has a housing containing aluminum as an exterior that wraps around the lithium ion secondary battery. Examples of the housing include those made only of aluminum and those containing aluminum, iron, aluminum laminate, and the like. The lithium ion battery waste may also contain, in the above housing, cathode active materials composed of one single metal oxide containing lithium and one selected from the group consisting of nickel, cobalt and manganese, or a composite metal oxides containing lithium and two or more of those, or the like, and aluminum foils (cathode substrates) to which the cathode active materials are applied and fixed by, for example, polyvinylidene fluoride (PVDF) or other organic binders. In addition, the lithium ion battery waste may contain copper, iron, or the like. Further, the housing of the lithium ion battery waste typically contains an electrolytic solution having an electrolyte such as lithium hexafluorophosphate dissolved in an organic solvent. As the organic solvent, ethylene carbonate, diethyl carbonate or the like may be used, for example.

### (Preprocessing Step)

In many cases, the lithium ion battery waste is subjected to preprocessing step. The preprocessing step may include at least one of roasting, crushing and sieving. The lithium ion battery waste becomes battery powder through the preprocessing step. The roasting, crushing, and sieving in the preprocessing step may optionally be performed, respectively, or they may be performed in any order. The battery powder means the powder obtained by subjecting the lithium ion battery waste to any preprocessing to separate and concentrate cathode material components. The battery powder may be obtained as a powder by crushing and sieving the lithium ion battery waste with or without a heat treatment to concentrate the cathode material components.

In the roasting, the above lithium ion battery waste is heated. When the roasting is carried out, metals such as lithium and cobalt contained in the lithium ion battery waste is changed to an easily dissolvable form. During the roasting, the lithium ion battery waste is preferably heated by maintaining it in a temperature range of, for example, from 450° C. to 1000° C., preferably in a temperature range of from 600° C. to 800° C., for 0.5 to 4 hours. In the roasting, one of the heating in an air atmosphere or the heating in an inert atmosphere such as nitrogen can be carried out, as well as both the heating in the air atmosphere and the heating in the inert atmospheres may be carried out in this order or opposite order. The roasting can be of butch type or continuous type. For example, the batch type includes a stationary furnace, the continuous type includes a rotary kiln furnace, and other various types of furnaces can also be used.

During the roasting, at least a part of the electrolytic solution is removed from the lithium ion battery waste because the electrolytic solution is evaporated, or the like. In many cases, when the lithium ion battery waste is heated during the roasting, the components of the internal electrolytic solution are sequentially evaporated, starting with the component having a lower boiling point. When the roasting is carried out, the electrolytic solution is removed and rendered harmless, and the organic binder is decomposed to promote separation between the aluminum foil and the cathode active material during crushing and sieving, which will be described below. Although the composition of the cathode active material changes due to roasting, the material that has undergone roasting is also referred to as the cathode active material.

After the roasting, the crushing can be carried out to remove cathode active materials and the like from the housing of the lithium ion battery waste. The crushing selectively separates the cathode active materials from the aluminum foils to which the cathode active materials are applied, while destroying the housing of the lithium ion battery waste.

Various known apparatuses or devices can be used in the crushing. In particular, it is preferable to use an impact-type crusher that can crush lithium ion battery waste by applying an impact while cutting it. Examples of the impact-type crusher include a sample mill, a hammer mill, a pin mill, a wing mill, a tornado mill, and a hammer crusher. It should be noted that a screen can be installed at an exit of the crusher, whereby the lithium ion battery waste is discharged from the crusher through the screen when crushed to a size that can pass through the screen.

After crushing the lithium ion battery waste, the sieving is performed by sieving it using a sieve having an appropriate sieve opening. Thus, aluminum or copper remains on the sieve, and the battery powder that has removed Al or Cu to some extent can be obtained under the sieve.

The battery powder obtained in the preprocessing step contains nickel, cobalt, lithium, manganese, and the like. For example, a content of nickel in the battery powder is 1% to 30% by mass, a content of cobalt is 1% to 30% by mass, a content of lithium is 2% to 8% by mass, a content of manganese is 1% to 30% by mass, although not limited thereto. The battery powder may further contain 1% to 10% by mass of aluminum, 1% to 5% by mass of iron, and 1% to 10% by mass of copper.

### (Acid Leaching Step)

In the acid leaching step, the battery powder is leached with an acidic leaching solution of a mineral acid such as sulfuric acid, hydrochloric acid, and nitric acid. As a result, the metals in the battery powder are dissolved to obtain a solution containing metal ions and anions of an inorganic acid, and a leached residue that has remained undissolved. As used herein, the solution in which the metals in the battery powder are dissolved in each step to the nickel extraction step as described below after the end of the acid leaching step is also referred to as a metal-containing solution.

In the acid leaching step, the pH of the acidic leaching solution or leached solution may be, for example, less than 3.5. Moreover, an oxidation-reduction potential (ORP value, based on silver/silver chloride potential) may be 100 mV or less. After leaching, solid-liquid separation may be performed to separate the leached residue from the metal-containing solution, but the solid-liquid separation may not be performed and the metal-containing solution containing the leached residue may be subjected to the next neutralization step. Here, as a diluent for adjusting the pH of the acidic leaching solution in the leaching step, an extracted solution (an aqueous lithium sulfate solution or the like) in a nickel extraction step as described below can be used. Thus, the lithium ions are circulated in a series of steps in the wet processes, and the lithium ions in the solution can be concentrated in the steps.

The metal-containing solution obtained in the acid leaching step may have, for example, a nickel ion concentration of 10 g/L to 50 g/L, a cobalt ion concentration of 5 g/L to 50 g/L, a lithium ion concentration of 2 g/L to 10 g/L, a manganese ion concentration of 0 g/L to 50 g/L, an aluminum ion concentration of 1.0 g/L to 20 g/L, an iron ion concentration of 0.1 g/L to 5.0 g/L, and a copper ion concentration of 0.005 g/L to 0.2 g/L.

### (Neutralization Step)

When the metal-containing solution obtained in the acid leaching step contains aluminum ions and/or iron ions, first, the neutralization step can be carried out by increasing the pH of the metal-containing solution to separate a neutralized residue to obtain a neutralized solution. The neutralization step may include an aluminum removal stage and an iron removal stage. However, if the metal-containing solution does not contain aluminum ions and/or iron ions, the aluminum removal step and/or iron removal step may be omitted.

In the aluminum removal step, the pH of the metal-containing solution is increased to precipitate at least a part of the aluminum ions and remove them by solid-liquid separation. At this time, for example, when the pH is increased in the range of 4.0 to 5.0 with a pH adjusting agent at a solution temperature of 50° C. to 90° C., the aluminum ions can be effectively separated while suppressing precipitation of nickel ions and/or cobalt ions.

In the iron removal step, an oxidizing agent is added and a pH adjusting agent is further added to increase the pH in a range of 4.0 to 5.0. As a result, the iron ions are oxidized from divalent to trivalent, and precipitated as a solid such as an oxide or iron hydroxide (Fe(OH)₃), which can be removed by solid-liquid separation. The oxidation-reduction potential (ORP value, based on silver/silver chloride potential) during oxidation is preferably 300 mV to 900 mV. The oxidizing agent is not particularly limited as long as it can oxidize iron, but it may preferably be manganese dioxide, a cathode active material, and/or a manganese-containing leached residue obtained by leaching a cathode active material. The manganese-containing leached residue obtained by leaching the cathode active material with the acid may include manganese dioxide. When the cathode active material or the like is used as the oxidizing agent, it causes a precipitation reaction which converts manganese dissolved in the liquid to manganese dioxide, so that the precipitated manganese can be removed together with iron.

Examples of the pH adjusting agent used in neutralization in the above aluminum removal stage and iron removal stage include lithium hydroxide, sodium hydroxide, sodium carbonate, and ammonia. The use of lithium hydroxide is preferable because it is possible to prevent sodium and the like from being mixed into lithium hydroxide recovered in a hydroxylation step as described below. In addition, when a lithium hydroxide solution obtained in the hydroxylation step or crystallization step is used, lithium ions are circulated in the wet processes.

### (Manganese Extraction Step)

The metal-containing solution can be subjected to a solvent extraction method to extract and remove the manganese ions, after undergoing the above neutralization step if necessary. Here, when aluminum ions remain in the metal-containing solution, the manganese ions as well as the aluminum ions are also extracted and removed.

In the extraction of the manganese ions, an extracting agent containing a phosphate ester-based extracting agent is preferably used. Specific examples of the phosphate ester-based extracting agent include di-2-ethylhexyl phosphate (abbreviated name: D2EHPA, for example, trade name: DP8R). Further, the extracting agent may be a mixture of the phosphate ester-based extracting agent and an oxime-based extracting agent. In this case, the oxime-based extracting agent is preferably aldoxime or based on aldoxime. Specific examples include 2-hydroxy-5-nonylacetophenone oxime (trade name: LIX84), 5-dodecyl salicylaldoxime (trade name: LIX860), a mixture of LIX84 and LIX860 (trade name: LIX984), 5-nonyl salicylaldoxime (trade name: ACORGAM5640) and the like.

The extracting agent may be diluted with an aromatic, paraffinic, naphthenic, or other hydrocarbon organic solvent to a concentration of 10% to 30% by volume and used as a solvent.

During extraction, an equilibrium pH is preferably 2.3 to 3.5, and more preferably 2.5 to 3.0. As the pH adjusting agent used at this time, a lithium hydroxide solution is preferably used, and for example, a lithium hydroxide solution obtained in a hydroxylation step or a crystallization step as described below can be used.

As an example, the extraction is more specifically carried out by bringing a solution (aqueous phase) into contact with a solvent (organic phase), stirring and mixing them, typically with a mixer, for example, for 5 to 60 minutes, to allow the metal ions to react with the extracting agent. The temperature during extraction is from ordinary temperature (approximately 15 to 25° C.) to 60° C. or lower, and it is preferably carried out at 35 to 45° C. for reasons of an extraction rate, phase separation, and evaporation of the organic solvent. The mixed organic phase and aqueous phase are then separated in a settler based on a difference in specific gravity. Extraction in steps other than the manganese extraction step can also be carried out in substantially the same manner.

At the time of extraction, it is desirable to carry out extraction by countercurrent type multistage extraction in which directions of flow of the aqueous phase and the solvent used for each extraction are opposite to each other. By doing so, the extraction of cobalt ions, nickel ions, and lithium ions can be suppressed, and the extraction rate of manganese ions can be increased. In the case of the countercurrent type multistage extraction, it is effective to set the equilibrium pH at the first stage of extraction to a value in the above range, and lower the equilibrium pH at the time of extraction through successive stages.

The cobalt ion concentration in the metal-containing solution after the manganese extraction step is, for example, 0 g/L to 50 g/L, typically 1 g/L to 15 g/L, and the nickel ion concentration is, for example, 0 g/L to 50 g/L. L, typically from 1 g/L to 20 g/L, and the lithium ion concentration is, for example, 1 g/L to 30 g/L, typically 5 g/L to 20 g/L.

### (Cobalt Extraction Step and Crystallization Step)

After manganese ions are extracted, cobalt ions can be extracted and separated from the metal-containing solution by a solvent extraction method.

It is preferable to use a solvent containing a phosphoric acid-based extracting agent, especially a phosphonate ester-based extracting agent, for the extraction of the cobalt ions. Particularly, 2-ethylhexyl 2-ethylhexylphosphonate (trade name: PC-88A, Ionquest 801) is preferable from the viewpoint of separation efficiency between nickel and cobalt. The extracting agent may be diluted with a hydrocarbon-based organic solvent so as to have a concentration of 10% by volume to 30% by volume and used as a solvent.

When extracting the cobalt ions, the equilibrium pH during extraction is preferably 5.0 to 6.0, and more preferably 5.0 to 5.5. If the pH is less than 5.0, cobalt ions may not be sufficiently extracted into the solvent. As the pH adjusting agent at this time, a lithium hydroxide solution is preferably used, for example, a lithium hydroxide solution obtained in a hydroxylation step or a crystallization step as described below can be used.

In the extraction of the cobalt ions as well, it is desirable to carry out the extraction by countercurrent type multistage extraction in which directions of flow of the aqueous phase and the solvent used for each extraction are opposite to each other. By doing so, it is possible to increase an extraction rate of cobalt ions while suppressing the extraction of nickel ions and lithium ions.

During the above extraction, not only cobalt ions but also nickel ions and lithium ions may be somewhat extracted into the solvent. In this case, if necessary, the solvent that has extracted the cobalt ions may be subjected to one or more scrubbing processes using a scrubbing solution to remove nickel ions and lithium ions that may be contained in the solvent. The scrubbing solution can be, for example, a sulfuric acid solution having a pH of 3.5 to 5.5. The scrubbed solution may contain nickel ions and lithium ions. Therefore, a part or all of the scrubbed solution is mixed with the metal-containing solution after the manganese extraction step and it is used as an extracting solution to carry out the cobalt extraction step. As a result, the nickel ions and lithium ions can be circulated or retained in the wet processes without losing them. However, if the solvent used to extract the cobalt ions does not contain nickel ions or lithium ions, the scrubbing may not be performed.

The solvent containing the cobalt ions is then subjected to stripping. A stripping solution used for the stripping may be any inorganic acid such as sulfuric acid, hydrochloric acid, and nitric acid, but sulfuric acid is preferable when a sulfate is obtained in the next crystallization step. Here, it is carried out under pH conditions such that all the cobalt ions transfer from the solvent to the stripping solution as much as possible. More particularly, the pH is preferably in the range of 2.0 to 4.0, and more preferably in the range of 2.5 to 3.5.

The stripped solution can be subjected to a crystallization step. In the crystallization step, the stripped solution is heated to, for example, 40° C. to 120° C. and concentrated. As a result, the cobalt ions are crystallized to obtain a cobalt salt such as cobalt sulfate. The cobalt salt thus obtained preferably has a nickel content of 5 ppm by mass or less, and have sufficiently removed the nickel, so that it can be effectively used as a raw material for producing lithium ion batteries of other batteries. Here, the crystallized solution may contain uncrystallized cobalt ions and lithium ions. Therefore, it is preferable that the crystallized solution is mixed with the stripped solution before the crystallization step and used for recrystallization step, or used for adjusting the cobalt ion concentration of the scrubbing solution used for the solvent that has extracted the cobalt ions, or mixed with the metal-containing solution after the manganese extracting agent and used for the cobalt extraction step. By doing so, the cobalt ions and lithium ions can be circulated or retained and concentrated in the wet processes without losing them.

### (Nickel Extraction Step and Crystallization Step)

The metal-containing solution after extracting the cobalt ions in the cobalt extraction step mainly contains nickel ions and lithium ions. In order to recover the nickel ions from the metal-containing solution, the nickel ions can be extracted from the metal-containing solution into a solvent by a solvent extraction method.

The extraction may employ a mixer-settler. In this case, first, the pH is adjusted by, for example, including a pH adjusting agent in the solvent, and then mixing the metal-containing solution (aqueous phase) with the solvent (organic phase) in a mixer to form a mixed solution, which is stirred. At this time, the nickel ions in the metal-containing solution migrate to the solvent. The mixed solution is then left to stand in a settler, and the aqueous phase and organic phase are separated based on a difference between their specific gravities. This provides an extracted solution that has separated the solvent.

Here, if the content of aluminum in the metal-containing solution subjected to the above neutralization step is higher, or if amounts of components to be extracted in each extraction step are larger, an amount of a pH adjusting agent required for adjusting the pH increases. When the lithium hydroxide solution is used as the pH adjusting agent, the metal-containing solution used for the above extraction may have a higher lithium ion concentration to some extent. Further, as described above, when the extracted solution (aqueous lithium sulfate solution or the like) for the nickel extraction step is used as a diluent for adjusting the pH of the acidic leaching solution in the acid leaching step, the lithium ion concentration of the metal-containing solution used for the above extraction may be higher to some extent.

In this case, if the pH adjusting agent containing the lithium ions such as a lithium hydroxide solution is used to adjust the equilibrium pH during the nickel ion extraction, the lithium ion concentration locally increases at positions where the above metal-containing solution and the pH adjusting agent are contacted with each other, and precipitates are formed there due to exceeding of the lithium ion concentration of the saturated lithium salt solution. In particular, a lithium hydroxide solution which is a crystallized solution obtained in a crystallization step as described below often has a higher lithium ion concentration as it is closer to the saturated concentration. Therefore, when that solution is used as a pH adjusting agent to extract the nickel ions, the precipitates tend to be generated.

In contrast, in this embodiment, the lithium ion concentration of the metal-containing solution and/or the lithium ion concentration of the pH adjusting agent are previously adjusted, such that the total of the lithium ion concentration of the metal-containing solution and the lithium ion concentration of the pH adjusting agent is less than or equal to the lithium ion concentration of the saturated lithium salt solution. This can lead to the suppression of the generation of the lithium salt even if the lithium ion concentration locally increase.

The saturated lithium salt solution as used herein refers to a lithium ion concentration of a saturated solution of a lithium salt formed by lithium ions and anions of major inorganic acids (sulfate ions, nitrate ions, chloride ions, etc.) contained in the metal-containing solution. If the metal-containing solution contains the greatest amounts of the sulfate ions, among the anions of the inorganic acid contained therein, the above lithium salt is lithium sulfate. Further, in many cases, solubility depends on a temperature, so that the above solubility is defined as solubility at a temperature when the extraction is performed.

During the above extraction, the precipitates are generated in the mixer-settler, and the precipitates clog pipes, so that the extraction operation cannot be smoothly performed. The precipitates may contain lithium, specifically a mixture of, for example, Li₂SO₄(H₂O) and the oil of the solvent.

In the extraction in the nickel extraction step, if the lithium ion concentration of the pH adjusting agent is not taken into account, or if the lithium ion concentration of the lithium hydroxide solution as the pH adjusting agent is at a predetermined value, it may be preferable to adjust the lithium ion concentration of the metal-containing solution so that the lithium ion concentration of the extracted solution separated from the solvent is less than 15 g/L. As an example, the predetermined value described above may be 28 g/L. This suppresses the generation of precipitates, and in some cases, substantially no precipitate may be generated. However, as described above, even if the lithium ion concentration of the extracted solution separated from the solvent is more than 15 g/L, the generation of the precipitates can be suppressed if the total lithium ion concentration of the metal-containing solution and the pH adjusting agent is below the solubility of the lithium salt. In addition, it should be noted that if the lithium ion concentration of the solution separated from the solvent in the settler after the extraction is lower than the lithium ion concentration of the saturated lithium salt solution, it is highly likely that no precipitate will be generated there.

From the viewpoint of preparing a sufficient amount of lithium hydroxide solution in the hydroxylation step, it is desirable to increase the lithium ion concentration of the metal-containing solution to some extent. On the other hand, if the metal-containing solution has a higher lithium ion concentration, there is a risk that precipitates will be generated during extraction as described above. Therefore, the lithium ion concentration of the extracted solution separated from the solvent is preferably 10 g/L to 14 g/L.

The lithium ion concentration of the aqueous phase (metal-containing solution, extracted solution) before and after extraction may vary, for example, depending on the amount of the pH adjusting agent in the solvent before mixing with the metal-containing solution. Therefore, as described above, the lithium ion concentration that can suppress the generation of the precipitates are defined herein for the extracted solution separated from the solvent after addition of the pH adjusting agent. Further, it is preferable that the lithium ion concentration of the metal-containing solution before extraction is 9 g/L to 13 g/L. This allows the generation of precipitates to be more effectively suppressed.

The solvent used in the nickel extraction step preferably contains a carboxylic acid-based extracting agent. Examples of the carboxylic acid-based extracting agent include neodecanoic acid and naphthenic acid. Among them, the neodecanoic acid (Versatic Acid 10 (VA-10) manufactured by Shell Chemicals) is preferred because of its ability to extract nickel ions. The extracting agent may be diluted with an aromatic, paraffinic, naphthenic, or other hydrocarbon-based organic solvent to a concentration of 10% to 30% by volume and used as a solvent. In addition, the above precipitates would be generated even if extracting agents other than the carboxylic acid-based extracting agent are used.

The equilibrium pH during the extraction is preferably 6.0 to 8.0, and more preferably 6.8 to 7.2. The pH adjusting agent used to adjust the pH at this time is preferably a lithium hydroxide solution, for example, a lithium hydroxide solution obtained in a hydroxylation step as described below can be used.

The extraction is preferably carried out in multiple stages using a countercurrent method in which the metal-containing solution and the solvent flow in opposite directions. By doing so, the extraction of lithium ions into the solvent can be suppressed, and the extraction rate of nickel ions can be increased. When performing multi-stage countercurrent extraction, it is effective, for example, to set the equilibrium pH during the first stage of extraction to a value within the above range, and then lower the equilibrium pH through successive stages of extraction. When carrying out the multi-stage countercurrent extraction, in each stage of extraction, the lithium ion concentration of the extracted solution separated from the solvent is preferably less than 15 g/L, and the lithium ion concentration of the metal-containing solution is preferably 9 g/L to 13 g/L.

In order to adjust the lithium ion concentration as described above, water or other diluent such as a desalted solution as described below can be added to the metal-containing solution at any time before mixing with the solvent during extraction to dilute the metal-containing solution. The timing of dilution is not particularly limited as long as it is from the time when the metal-containing solution is obtained in the acid leaching step and before mixing with the solvent during the extraction in the nickel extraction step. However, if it is very long before the nickel extraction step, an increase in a volume of the metal-containing solution caused by the dilution may cause problems of conveyance and handling of the metal-containing solution between the steps. Therefore, it is preferable to dilute the metal-containing solution immediately before mixing with the solvent during the extraction in the nickel extraction step.

In addition, if the content of aluminum in the battery powder is higher, it will be necessary to add a large amount of lithium hydroxide solution as a pH adjusting agent in the neutralization step as described above, and the lithium ion concentration of the metal-containing solution tends to increase accordingly. From the viewpoint of reducing the burden of adjusting the lithium ion concentration, it is desirable that the content of aluminum in the battery powder is lower, for example, 3% by mass or less. When extracting the nickel ions, a pH adjusting agent may be added to the solvent before mixing with the metal-containing solution, and this solvent may be mixed with the metal-containing solution. In this case, when the solvent containing the pH adjusting agent is brought into contact with the metal-containing solution, a local increase in lithium ion concentration and the resulting generation of precipitates may become apparent. Therefore, especially when including the pH adjusting agent in the solvent in advance, it is effective that the total of the lithium ion concentration of the metal-containing solution and the lithium ion concentration of the pH adjusting agent is less than or equal to the solubility of the lithium salt.

Alternatively, the pH adjusting agent may be added in a dropping manner or the like when mixing the metal-containing solution with the solvent, or the metal-containing solution may be mixed with the pH adjusting agent before mixing with the solvent. Also at this time, it is preferable that the total of the lithium ion concentration of the metal-containing solution and the lithium ion concentration of the pH adjusting agent is equal to or less than the lithium ion concentration of the saturated lithium salt solution.

By the way, the solvent that has contained the nickel ions by the extraction may optionally be subjected to one or more scrubbing processes using a scrubbing solution to remove lithium ions that may be contained in the solvent. The scrubbing solution can be, for example, a sulfuric acid solution having a pH of 5.0 to 6.0. Here, the resulting scrubbed solution may contain lithium ions. Therefore, it is preferable that a part or all of the scrubbed solution is mixed with the metal-containing solution after the cobalt extraction step, and it is used as the extracting solution to carry out the nickel extraction step. As a result, the lithium ions can be circulated or retained and concentrated in the wet processes without losing them. However, if the solvent containing the nickel ions does not contain lithium ions, the scrubbing may not be performed.

The solvent containing the nickel ions is then subjected to stripping using a stripping solution. The stripping solution may be any inorganic acid such as sulfuric acid, hydrochloric acid, and nitric acid, but if a sulfate salt is obtained in the next crystallization step, sulfuric acid is preferred. The pH is preferably in the range of 1.0 to 3.0, and more preferably 1.5 to 2.5. Although the O/A ratio and the number of times can be determined as needed, the O/A ratio is 5 to 1, and more preferably 4 to 2.

When the extracted solution such as a nickel sulfate solution is obtained by the stripping, electrolysis and dissolution can be carried out as needed, and the solution can be then heated to 40° C. to 120° C. in the crystallization step to crystalize the nickel ions as a nickel salt such as nickel sulfate. This provides the nickel salt. Here, the crystallized solution may contain uncrystallized nickel ions and lithium ions. Therefore, the crystallized solution is mixed with the stripped solution before the crystallization step and used for a recrystallization step, or used for adjusting the nickel ion concentration of the scrubbing solution with respect to the solvent containing the nickel ions, or mixed with the metal-containing solution after the cobalt extraction step and used for the nickel extraction step. By doing so, the nickel ions and lithium ions can be circulated or retained and concentrated in the wet processes without losing them.

The extracted solution in which the nickel ions have transferred to the solvent mainly contains lithium ions and may be added to the acidic leaching solution in the acid leaching step. This allows the lithium ions contained in the extracted solution to be circulated in a series of steps from the acid leaching step to the nickel extraction step. Preferably, after the lithium ion concentration in the nickel extracted solution has been increased to some extent by thus circulating the lithium ions, a hydroxylation step as described below can be carried out.

### (Hydroxylation Step)

In the hydroxylation step, a lithium hydroxide solution is prepared from the above extracted solution such as a lithium sulfate solution. The details of the hydroxylation step are not particularly limited as long as the lithium hydroxide solution can be prepared, but, for example, it can employ a carbonation and chemical conversion method that uses calcium hydroxide after preparing lithium carbonate, a chemical conversion method that uses barium hydroxide, an electrodialysis method, and the like.

For the carbonation and chemical conversion method, first, a lithium carbonate solution is obtained by adding a carbonate to or blowing a carbon dioxide gas into a lithium-containing solution. Subsequently, in a so-called chemical conversion method, calcium hydroxide can be added to the lithium carbonate solution to generate the lithium hydroxide solution under the reaction formula: Li₂CO₃+Ca(OH)₂→2LiOH+CaCO₃. Calcium ions that may remain in the solution can be removed with a cation exchange resin, a chelate resin, or the like.

When barium hydroxide is used, barium hydroxide can be added to the lithium-containing solution to obtain the lithium hydroxide solution based on the reaction: Li₂SO₄+Ba(OH)₂→2LiOH+BaSO₄. At this time, barium that can be dissolved in the solution can be separated and removed using a cation exchange resin, a chelate resin, or the like.

For the electrodialysis, in a bipolar membrane electrodialysis device, the lithium-containing solution is introduced into a desalting chamber between an anion exchange membrane and a cation exchange membrane, and pure water is introduced into each of an acid chamber between a bipolar membrane and an anion exchange membrane and an alkaline chamber between a cation exchange membrane and a bipolar membrane, and a voltage is applied between the electrodes. Then, the lithium ions in the metal-containing solution in the desalting chamber move to the alkaline chamber where the bipolar membrane decomposes the pure water into hydroxide ions to obtain a lithium hydroxide solution. It should be noted that anions of an inorganic acid such as sulfate ions in the metal-containing solution in the desalting chamber pass through the anion exchange membrane and move to the acid chamber.

Furthermore, for electrodialysis, as a result of separating most of the lithium salts from the metal-containing solution in the desalting chamber, a desalted solution containing substantially no lithium salts is obtained. However, the desalted solution may contain minor amounts of lithium ions. From the perspective of reducing lithium loss, when the electrodialysis is used in the hydroxylation step, the dilution of the metal-containing solution to suppress the generation of precipitates during the extraction in the nickel extraction step as described above is preferably carried out by adding the desalted solution as a diluent to the metal-containing solution. This allows the lithium ion concentration of the metal-containing solution to be adjusted.

At least a part of the lithium hydroxide solution obtained as described above is effectively used as an alkaline pH adjusting agent used in the method for recovering metals (in the process of FIG. 1, at least one step selected from the group consisting of the neutralization step, the manganese extraction step, the cobalt extraction step, and the nickel extraction step).

### (Crystallizing Step)

A part of the lithium hydroxide solution obtained in the hydroxylation step can be subjected to a crystallizing step. For example, when the lithium hydroxide solution is returned to the wet process as a pH adjusting agent as described above, the lithium in the battery powder newly added to the wet process may gradually increase the lithium ion concentration in the liquid. Depending on the lithium ion concentration, the crystallizing step may be performed to recover lithium as lithium hydroxide.

In the crystallizing step, a crystallizing operation such as heat concentration or vacuum distillation can be performed in order to precipitate lithium hydroxide. For the heat concentration, a higher temperature during crystallizing leads to faster progression of the process, which is preferable. However, the temperature of the crystallized product after crystallizing can be a temperature of less than 60° C. at which water of crystallization is not released. This is because anhydrous lithium hydroxide from which the water of crystallization has been released is deliquescent and thus difficult to be handled. In addition, a pulverization process or the like can be then performed in order to adjust the above lithium hydroxide to required physical properties.

As described above, the lithium hydroxide solution obtained in the hydroxylation step is substantially free of anions of an inorganic acid such as sulfate ions. Therefore, the lithium hydroxide produced in the crystallization step will have high purity and excellent quality. The lithium hydroxide solution obtained by separating the lithium hydroxide produced in the crystallizing step by solid-liquid separation may be used as a pH adjusting agent in the neutralization step, the manganese extraction step, the cobalt extraction step, and/or the nickel extraction step.

### EXAMPLES

Next, the method for recovering metals as described above was experimentally carried out and the effects thereof were confirmed, as described below. However, the descriptions herein are merely for illustrative and are not intended to be limited.

### Test Example 1

As shown in FIG. 1, the lithium hydroxide solution prepared in the hydroxylation step was used as a pH adjusting agent in each of the neutralization step, the manganese extraction step, the cobalt extraction step, and the nickel extraction step, and the processes are continuously carried out. The pH adjusting agent was a lithium hydroxide solution, and the lithium ion concentration was 28 g/L.

In the extraction of the nickel extraction step, the nickel ions were transferred from the metal-containing solution to the solvent using a solvent containing VA-10, a carboxylic acid-based extracting agent, for the metal-containing solution in the mixer-settler. The nickel ion concentration of the metal-containing solution before extraction was 8 to 12 g/L, and the nickel ion concentration of the extracted solution was 0.001 to 0.01 g/L. The solvent was a mixture of VA-10 and a hydrocarbon-based organic solvent, which contained VA-10 at a concentration of 25% by volume. The equilibrium pH during extraction was set to 6.8 to 7.2, typically about 7.0, using the above pH adjusting agent.

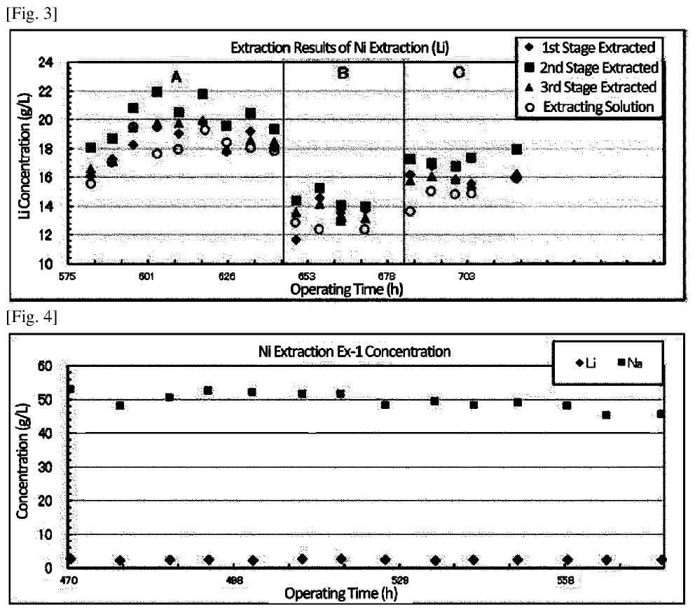

Then, the lithium ion concentration of each of the metal-containing solution before the above extraction (extracting solution) and the extracted solution (MS solution) in the mixer-settler was measured, and amounts of precipitates generated in the mixer-settler were visually confirmed. The results are shown in Table 1. Further, FIG. 3 shows a change of the lithium ion concentration in each solution over time. Here, a three-stage extraction was performed using a countercurrent method in which the flows of the metal-containing solution and the solvent were in opposite directions. FIG. 3 shows a change in the lithium ion concentration of the extracted solution in the mixer-settler during extraction at each stage.

TABLE 1

| Period | A | B | C |
|---|---|---|---|
| Extracting Solution | 18 to 20 of Li | 12 to 13 of | 15 to 16 of Li |
| (g/L) | | Li | |
| MS Solution (g/L) | 18 to 22 of Li | 13 to less | 15 to 18 of Li |
| | | than 15 of Li | |
| Amounts of Precipitates | many | slight | medium |
| (Visually Confirmed) | | | |

It should be noted that, in Period A, the metal-containing solution was not diluted before extraction, whereas in periods B and C, the metal-containing solution was diluted with water before extraction. As a result, the lithium ion concentration of each solution was reduced in periods B and C, as shown in Table 1 and FIG. 3, depending on the degree of dilution.

The anions of the inorganic acid contained in the extracting solution are sulfate ions, and the lithium ion concentration in the saturated solution of lithium sulfate as the lithium salt (the lithium ion concentration of the saturated lithium salt solution) is 42.5 g/L at a temperature during extraction (40° C.). The lithium ion concentration of the saturated lithium salt solution can be determined from a concentration of lithium sulfate (Li₂SO₄) of 337 g/L in the saturated lithium sulfate solution at 40° C. by the equation: 337×6.94×2/109.945≈42.5. Since the lithium ion concentration of the pH adjusting agent is 28 g/L, the total concentration of the lithium ion concentration of the extracting solution and the lithium ion concentration of the pH adjusting agent is 46 g/L to 48 g/L in Period A, which was higher than the lithium ion concentration of the saturated lithium salt solution (42.5 g/L). In Period B, the total concentration is 40 g/L to 41 g/L, which was lower than the lithium ion concentration of the saturated lithium salt solution (42.5 g/L). In Period C, the total concentration is 43 g/L to 44 g/L, which was higher than the lithium ion concentration of the saturated lithium salt solution (42.5 g/L).

As a result, as shown in Table 1 and FIG. 3, relatively large amounts of precipitates were generated in Periods A and C. On the other hand, in Period B, almost no precipitates were generated.

The precipitates generated in the mixer-settler were analyzed by X-ray diffraction (XRD), and it was confirmed that the precipitates contained Li₂SO₄ (H₂O). Further, from the fact that the precipitates were not dissolved in water or an acid and from the properties of the precipitates, it was estimated that the precipitates were a mixture of Li₂SO₄ (H₂O) and oil.

### Test Example 2

In the processes shown in FIG. 1, the same processes were continuously carried out with the exception that the lithium hydroxide solution prepared in the hydroxylation step was not used, a separately prepared hydroxide solution was used as a pH adjusting agent in each of the neutralization step, the manganese extraction step, the cobalt extraction step, and the nickel extraction step. In this case, the lithium ion concentration and the sodium ion concentration of the metal-containing solution to be subjected to the nickel extraction step were measured, and a change of each concentration over time was confirmed. The results are shown in FIG. 4.

It is found from FIG. 4 that when sodium hydroxide is used as the pH adjusting agent, the lithium ion concentration of the metal-containing solution continues to be sufficiently low. Further, no precipitate was generated in the mixer-settler used for extraction in the nickel extraction step. This indicates that the generation of precipitates becomes obvious when the lithium hydroxide solution is used as a pH adjusting agent and lithium is circulated in a wet process as in Test Example 1. Therefore, in such a case, it is believed that the method for recovering metals as described above would be particularly effective.

### Test Example 3

The extraction in the nickel extraction step was carried out in substantially the same method as that of Test Example 1.

Here, the lithium hydroxide solution obtained in the hydration step was used as a pH adjusting agent. The lithium ion concentration of the pH adjusting agent was 12 g/L, and the lithium ion concentration of the extracting solution was 17 g/L or less. The total of the lithium ion concentration of the pH adjusting agent and the lithium ion concentration of the metal-containing solution is 29 g/L or less. When the extraction was carried out under these conditions with an equilibrium pH of 6.8 to 7.0, no precipitate was generated. It should be noted that the lithium ion concentration of the extracted solution after separation from the solvent was 18 g/L or less.

In view of the foregoing, it was found that the method for recovering metals as described above can effectively suppress the generation of precipitates during the extraction of nickel ions.

1. A method for recovering metals from a metal-containing solution containing nickel ions, lithium ions, and anions of an inorganic acid, the method comprising:
a nickel extraction step including extraction that mixes the metal-containing solution with a solvent while adjusting an equilibrium pH using a pH adjusting agent containing lithium ions, transfers the nickel ions in the metal-containing solution to the solvent, and separates the solvent containing the nickel ions from an extracted solution,
wherein, in the nickel extraction step, the extraction is carried out under conditions where a total of a lithium ion concentration of the metal-containing solution and a lithium ion concentration of the pH adjusting agent is less than or equal to a lithium ion concentration of a saturated solution of a lithium salt made of the anions of the inorganic acid and the lithium ions contained in the metal-containing solution.

2. The method for recovering metals according to claim 1, wherein the lithium ion concentration of the metal-containing solution is adjusted so that the lithium ion concentration of the extracted solution separated from the solvent is less than 15 g/L in the extraction of the nickel extraction step.

3. The method for recovering metals according to claim 2, wherein in the nickel extraction step, the lithium ion concentration of the extracted solution separated from the solvent is 10 g/L to 14 g/L.

4. The method for recovering metals according to claim 1, wherein in the nickel extraction step, the lithium ion concentration of the metal-containing solution before the extraction is 9 g/L to 13 g/L.

5. The method for recovering metals according to claim 1,
wherein the extraction of the nickel extraction step is carried out in multiple stages by a countercurrent method in which flows of the metal-containing solution and the solvent are in opposite directions, and
wherein, in the extraction in each stage, the lithium ion concentration of the extracted solution separated from the solvent is less than 15 g/L.

6. The method for recovering metals according to claim 1, wherein in the nickel extraction step, the solvent containing a carboxylic acid-based extracting agent is used, and an equilibrium pH of the extraction is 6.0 to 8.0.

7. The method for recovering metals according to claim 1, wherein the lithium salt is lithium sulfate, and the metal-containing solution comprises sulfate ions as the anions of the inorganic acid.

8. The method for recovering metals according to claim 1, further comprising a hydroxylation step of preparing a lithium hydroxide solution from the extracted solution obtained in the nickel extraction step, wherein at least a part of the lithium hydroxide solution is used as a pH adjusting agent used in the method for recovering metals.

9. The method for recovering metals according to claim 8,
wherein, in the hydroxylation step, the lithium hydroxide solution is prepared by electrodialysis, and the lithium salt is separated from the extracted solution to obtain a desalted solution, and
wherein the desalted solution is added to the metal-containing solution to dilute the metal-containing solution, and to adjust the lithium ion concentration of the metal-containing solution.

10. The method for recovering metals according to claim 1, wherein, in the nickel extraction step, the pH adjusting agent is included in the solvent before mixing the metal-containing solution with the solvent.

11. The method for recovering metals according to claim 1, wherein, in the nickel extraction step, the pH adjusting agent is added upon mixing of the metal-containing solution with the solvent, and/or the metal-containing solution is mixed with the pH adjusting agent before the metal-containing solution is mixed with the solvent.
